(19) United States
(12) Patent Application Publication
(10) Pub. No.: US 2005/0070218 A1
(43) Pub. Date: Mar. 31, 2005

(54) Phased agitation and controlled oleiferous material separation by liquid gas solvent

(76) Inventors: Darrell James Phillips, Zachary, LA (US); George Baxter Russell, Baton Rouge, LA (US)

Correspondence Address: GEORGE BAXTER RUSSELL, 7967 OFFICE PARK BLVD, BATON ROUGE, LA, 70809, US

(21) Appl. No.: 10/892,064

(22) Filed: Jul. 14, 2004

Related U.S. Application Data
(60) Provisional application No. 60/486,743, filed on Jul. 14, 2003.

(51) Int. Cl. A22C 21/06

(52) U.S. Cl. 452/122

(57) ABSTRACT

A new and improved invention for the truly continuous extraction of oleiferous and carbonaceous content contained in rendered animal tissue and the full range of subject solids material listed in Claim 1, by one or a series of pressured phased agitation chambers using an array of patterned sprays of solvent which is a gas in liquid form under pressure.

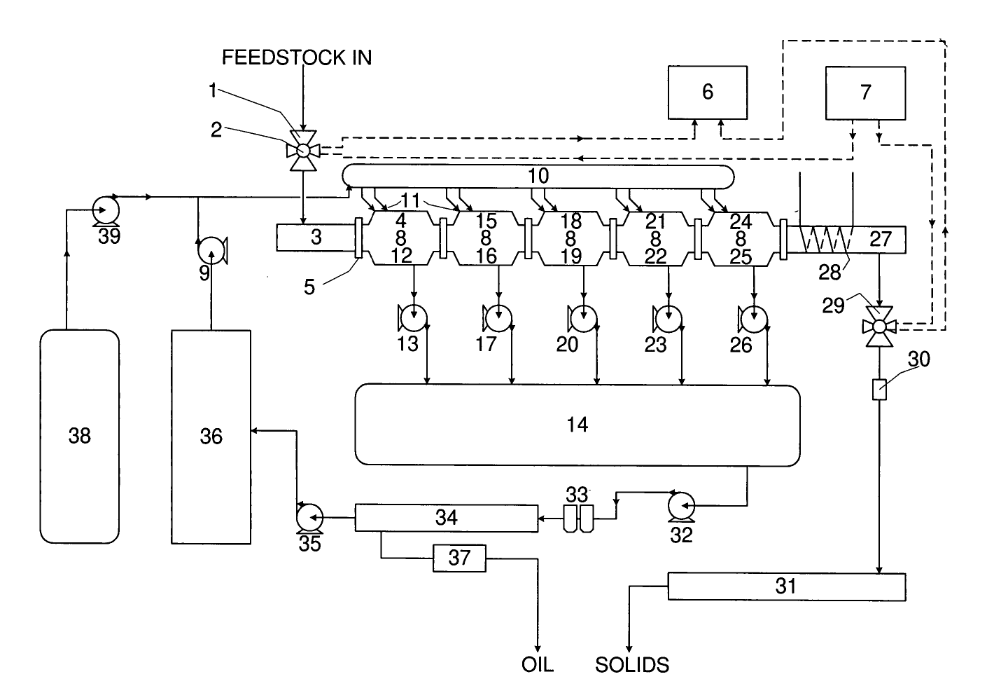

### CROSS REFERENCE TO RELATED APPLICATIONS

United States Patent Documents

| | | | | |
|---|---|---|---|---|
| 1802533 | April | 1931 | Reid | 554/16 |
| 1849886 | March | 1932 | Rosenthal | 554/210 |
| 2247851 | July | 1934 | Rosenthal | 99/2 |
| 2281865 | May | 1942 | Van Dijck | 196/13 |
| 2538007 | Jan | 1951 | Kester | 99/153 |
| 2548434 | April | 1951 | Leaders | 260/428 |
| 2560935 | July | 1951 | Dickenson | 260/412 |
| 2564409 | Aug | 1951 | Rubin | 260/412 |
| 2682551 | Sept | 1954 | Miller | 260/412 |
| 2727914 | Dec | 1955 | Gastrock et al | 260/412 |
| 3261690 | July | 1966 | Wayne | 99/80 |
| 3565634 | Feb | 1971 | Osterman | 99/18 |
| 3923847 | Dec | 1975 | Roselius | 260/412 |
| 3939281 | Feb | 1976 | Schwengers | 426/113 |
| 3966981 | June | 1976 | Schultz | 426/425 |
| 3966982 | June | 1976 | Becker et al | 426/430 |
| 4331695 | May | 1982 | Zosel | 426/430 |
| 4617177 | Oct | 1986 | Schumacher | 422/273 |
| 4675133 | June | 1987 | Eggers et al | 260/412 |
| 4744926 | May | 1988 | Rice | 260/412 |
| 4765257 | Aug | 1988 | Abrishamian et al | 110/342 |
| 4770780 | Sept | 1988 | Moses | 210/634 |
| 5041245 | Aug | 1991 | Benado | 260/412 |
| 5210240 | May | 1993 | Peter | 554/11 |
| 5281732 | Jan | 1994 | Franke | 554/16 |
| 5405633 | April | 1995 | Heidlas et al | 426/442 |
| 5482633 | Jan | 1996 | Muraldihara | 210/651 |
| 5525746 | June | 1996 | Franke | 554/125 |
| 5707673 | Jan | 1999 | Pevost et al | 426/417 |

### BACKGROUND OF THE INVENTION

Mankind has extracted oleiferous materials from various feedstocks since history began and although man's early efforts were rudimentary, some of the extraction methods used today is mechanical continuums of those first efforts in extraction.

In the early 1930s a more efficient way was discovered for extracting a greater percent of the oleiferous material from the “subject solid materials” as listed in Claim 1 in the Claims made in this document. This more efficient way, however, has many drawbacks and does not allow for a prescribed percentage amount of oleiferous materials to remain in the subject solid materials. Nevertheless solvent extraction is now common practice in some industries using solvents as the extraction agent in a multiplicity of commercial applications in the petroleum, chemical, pharmaceutical and food industries.

Solvent separation is the most commonly used technology in the oleiferous material extraction industry today and, in current use, the technology consists of a fixed, in place, permanent extraction plant where feedstock is delivered for processing. In almost all cases and now routine current practice, the solvent hexane is used as the processing solvent. Hexane is a liquid at normal ambient temperatures and a vapor or gas when subjected to heat beyond its boiling temperature. Hexane has toxic and hazardous properties plus an unpleasant distinctive taste and aroma that is retained by both the subject solid materials and the oleiferous material after the extraction process is complete. Heat at a degree to flash-off the hexane into the atmosphere causes environmental damage, denatures vitamins and protein naturally occurring in both the subject solid materials and the oleiferous material, and also disturbs their color, chemical and molecular makeup.

In industry they use various extraction methods:
In the petroleum and chemical industries

Solvents are used in the recovery and the recycling of compounds created either by organic materials in waste streams, oil/water emulsions, or sludge from refinery operations. Examples of these processes are described in U.S. Pat. Nos. 4,765,257, 4770,780, 4,848,918 and 4,877,530.
In the pharmaceutical and food industry

Solvents are used to extract oils, fats and lipids from various feedstocks. The solvent of choice is hexane, which is a known carcinogen and is now under the scrutiny of the FDA in its further uses in the industry. To circumvent the problems of hexane, there has been a move toward propane, butane and even pentane. However the explosive nature of these solvents makes them unattractive to industry and their use brings with them OSHA restrictions and conditions. Most of the uses of these solvents are illustrated in U.S. Pat. Nos. 1,808,533, 1,849,866, 2,247,851, 2,281,865, 2,538,007, 2,548,434, 2,2560,936, 2,564,409, 2,682,551, 2,727,914, 3,261,690, 3,565,634, 3,923,847, 3,939,281, 3,966,981, 3,966,982, 4,331,695, 4,617,177, 4,6754,133, 5,041,245, 5,210,240, 5,281,732, 5,405,633, 5,482,633, 5,525,746, and 5,707,673.

This new and improved invention utilizes a solvent that is a gas at typical ambient temperatures and in this application is introduced in liquid phase under pressure then sustained under conditions to maintain it as a liquid. Propane and butane or mixtures thereof are useful and acceptable. The preferred solvent for this invention is a selected refrigerant controlled in a closed-loop system which has most of the properties of propane and butane but unlike them, is non-explosive. All these liquid gases are naturally pure, easy to obtain, non-toxic, low in health hazards and given a G.R.A.S. designation (Generally Regarded as Safe for food use) by the United States Food and Drug Administration.

This invention is free standing and self-contained. It is capable of being constructed fully mobile and moved from location to location by trailer. The invention also offers the ability to precisely control the amount of oleiferous material extracted. This control is determined by automated instrumentation and programming for each subject solid material in phased agitation chambers and is effected by adjusting the speed of a specially designed and constructed impeller, controlled patterns of solvent flow, force and effect of the solvent flow vortex upon the free floating, agitated and suspended particles resulting from the action impeller and the speed with which the pump vacuums the oleiferous compound from the extractor.

The significant utility of this invention is:
1. For the first time a truly continuous extractor has been invented using a closed-loop solvent system and allows for a truly continuous flow of subject solid materials feedstock through the extractor in a continuing extraction process while maintaining the extraction solvent in a liquid state circulating in a closed-loop system.
2. The modular design of the extractor, which can have single or multiple phased agitation chambers, allows for the customizing of the extractor for the different extraction rates of the various subject solid materials. Similarly the separation and collection systems can be customized to reflect the number of phased agitation chambers in an extractor unit.
3. The extractor is modular and fully automated having been preprogrammed to efficiently process the extraction of each of the subject solid materials so, if required, a single extractor has the ability to be adapted to meet the extraction criteria of many different subject solid materials.
4. The extraction and separation processes occur at ambient temperatures. There are no such appendages as boilers or refrigeration units needed as catalysts in heating or cooling the subject solid materials, solvent or the oleiferous/solvent emulsion at any time during the extraction of the oleiferous material and separation of oleiferous/solvent emulsion into their original states. The negation of such heating and cooling equipment creates energy savings at an expediential rate and drastically reduces the footprint size of the extractor. The process requires no flash off of the solvent into the atmosphere thereby reducing to almost zero the environmental impact on the quality of air standards.
5. The extractor is compatible with all nontoxic solvents and utilizes naturally pure liquid gases, the preferred ones being non-explosive refrigerants that are abundant, easy to obtain, non-toxic, low in health hazards and given a G.R.A.S. designation (Generally Regarded as Safe for food use) by the United States Food and Drug Administration that remain in a liquid state at all times.
6. The extraction and separation processes are “gentle” allowing subject solid materials and the oleiferous material to maintain undisturbed their molecular makeup, chemical structure, color and the vitamins and protein naturally occurring in both the oleiferous material and the subject solid materials.
7. The extraction process is enhanced by the ability to retain prescribed amounts of the oleiferous material in the subject solid materials when the extraction process is complete.
8. The extractor is free standing, self contained and capable of being fully mobile.
9. The original properties of both the subject solids material and the oleiferous material are retained post separation to considerably improve the value added opportunities of categorical applications.

After a review of the patents recorded, it appears that none of the patents in their operational description fulfill significant improvements listed above. In research, all of the other patents either have the necessity to feed or process batch feedstock or as part of their patent, require as part of the pseudo continuous process batching the feedstock into separate bins for pre-treatment or feed and batch solvent in a series of stills or evaporation tanks from a liquid to a vapor then back to a liquid. There is no patent that defines a truly continuous extraction process such as proffered in this document for both feedstock and solvent or meets the criteria of the nine significant utilities of this invention.

From this background it was apparent that there was a need for a truly continuous extraction process. Accordingly the objectives of this invention are to fill the need for a truly continuous extraction method that will become apparent from the following descriptions.

### BRIEF SUMMARY OF THE INVENTION

The invention creates a new and improved truly continuous way to extract oleiferous materials from the various subject solid materials mentioned in Claim 1 herein. The invention is free standing, self-contained and has the ability to be fully mobile and can be moved from location to location to points of need.

The applicants have discovered that through the creation of a proprietary valve assemblage consisting of various valve assemblies, manipulation of solvent flow, feedstock feed ratios, speed of transition of feedstock being impelled through the extraction chamber(s), maintaining of pressure and the creation of vacuum that they can monitor and extract the precise amount of oleiferous material in subject solid materials while maintaining the solvent as a liquid allowing for constant feedstock processing and the continuing recycling and integrity of the liquid solvents used.

The invention allows for subject solids material feedstock to be continually fed into the phased separation chambers through a proprietary valve assemblage from atmosphere to pressure without the loss of pressure in the extraction chamber and the release of vacuum in the closed solvent loop. By continually impelling the subject solids material feedstock along the length of the pressurized extractor's phased agitation chambers in a controlled and flayed fashion and soaking it with solvent, the applicants have discovered that they can extract precise measurements of oleiferous materials from the subject solids material named in Claim 1 herein. The sprayed solvent casts a precipitation on the subject solids material feedstock in certain areas of the phased separation chambers which causes leaching and creates an oleiferous/solvent emulsion which is then removed through a coarse filter into a holding chamber from whence it goes through further coalescence activity to separate and reconstruct the liquid solvent and separate oleiferous material into separate streams. The liquid solvent is recycled to process more subject solids material feedstock and the oleiferous material ejected to atmosphere for further use. The local environment and ambient temperatures of a situated extractor may on occasion necessitate some temperature controls to compensate for the expansion and compression of the solvent in the system.

Once processed, the subject solids material feedstock reaches the exit end of the extractor and is then removed by a second proprietary valve assemblage unit that maintains pressure in the extraction chamber and vacuum in the closed-loop solvent system. The subject solids material feedstock is continually fed and the solvent continually recycled to process a continuing flow of subject solids material feedstock.

In all existing technology a permanent extraction plant is constructed and materials that need the extraction process are brought to the site for processing. This new and improved extraction process is free standing, self contained, can be made fully mobile for transportation to sites of need either for applications such as by example but not excluding other applications, environmental remediation, seasonal crop processing, relocating from location to location to minimize trucking of feedstock that requires processing.

### DETAILED DESCRIPTION

### See Attached Drawing

1. “Subject solids materials” listed in Claim 1 of this document is the feedstock for the extractor and may be in pellet form or milled to a size previously determined for optimum separation. Subject solids material may be dried prior to separation if a liquid-free solid is desired after separation. Subject solids material is introduced at an ambient temperature under normal atmospheric conditions through a proprietary valve assemblage [Element 1.] containing multiple feedstock chambers [Element 2.] to the pre-agitation chamber [Element 3.], and into the phased agitation chambers [Element 4.] of the extractor [Element 5.].

2. In the proprietary valve assemblage [Element 1.], each continuous rotation of the multiple feedstock chambers [Element 2.] performs the multiple tasks of:

(a) The proprietary valve assemblage feedstock chambers [Element 2.], receive a precise amount of subject solids material feedstock,

(b) Purging air and moisture from the proprietary valve assemblage feedstock chamber [Element 2.],

(c) Releasing and propelling by the law of physics the subject solids material feedstock into the pre-agitation chamber [Element 3.], and the phased agitation chamber(s) [Elements 4, 15, 18, 21, & 24.], without the loss of pressure in the extractor, [Element 5.],

(d) Purging any residual vapors from the proprietary valve assemblage feedstock chamber [Element 2.] that may have entered it while releasing and propelling by the law of physics subject solids material into the pre-agitation chamber [Element 3.], of the phased agitation chambers [Element 4, 15, 18, 21, & 24.], of the extractor, [Element 5.],

(e) The feedstock chamber of the proprietary valve assemblage [Element 2.], upon completing one full revolution, is prepared to accept a new, continuing flow of subject solids material under normal atmospheric conditions for extraction processing.

3. The results of the above are that a continuous flow of precisely metered amount of subject solids material feedstock is delivered into the pre-agitation chamber under a controlled and pressured environment.

4. The vacuum and pressure needed for the satisfactory operation of the proprietary valve assemblage is provided for by a vacuum pump [Element 6.] and a compressor [Element 7.]

5. When the subject solids material feedstock transverses the proprietary valve assemblage and enters the pre-agitation chamber [Element 3.] an impeller [Element 8.] continuously moves it through the pre-agitation chamber [Element 3.] into phase one agitation chamber [Element 4.].

6. In the phase one agitation chamber [Element 4.], the impeller [Element 8] gently agitates, flays and propels subject solids material feedstock into separate and free floating particles.

7. A liquid gas solvent from pump [Element 9.], at a pressure greater than the resident extractor chamber pressure, is injected through and transits the spray nozzle manifold [Element 10.] by selected spray nozzles, creating different spray patterns [Element 11.] into the phase one agitation chamber [Element 4.] with a force, angle and droplet size to create a vortex of solvent and subject solids material feedstock in the phase one agitation chamber [Element 4.] which further agitates the subject solids material feedstock. The solvent saturates the agitated subject solids material feedstock particles causing the subject solids material feedstock to leach and create the precipitation of an oleiferous/solvent emulsion. The extractor pressure is maintained throughout extraction process in the phase one agitation chamber [Element 4.] ensuring the solvent remains in its liquid form.

8. A precise amount of oleiferous material is separated from the subject solids material feedstock in the phase one agitation chamber [Element 4.] creating an oleiferous/solvent emulsion. The oleiferous/solvent emulsion is drawn through a coarse filter [Element 12.] by a pump [Element 13.] from the phase one agitation chamber [Element 4.] thus negating the need for a pressure differential. During the passage of the oleiferous/solvent emulsion through the coarse filter some particulate matter from the subject solids material feedstock remains in the oleiferous/solvent emulsion and will be removed at a later step in the separation process. The oleiferous/solvent emulsion is moved to the storage collection tank [Element 14.]. The subject solids material feedstock partially processed continues to transverse the extractor with impeller [Element 8.] action and is carried into the phase two agitation chamber [Element 15.].

9. In the phase two agitation chamber [Element 15.], the impeller [Element 8] gently agitates, flays and propels subject solids material feedstock into separated and free floating particles.

10. A liquid gas solvent from pump [Element 9.], at a pressure greater than the resident extractor chamber pressure, is injected through and transits the spray nozzle manifold [Element 10.] by selected spray nozzles, creating different spray patterns [Element 11.] into the phase two agitation chamber [Element 15.] with a force, angle and droplet size to create a vortex of solvent and subject solids material feedstock in the phase two agitation chamber [Element 15.] which further agitates the subject solids material feedstock. The solvent saturates the agitated subject solids material feedstock particles causing the subject solids material feedstock to leach and create the precipitation of an oleiferous/solvent emulsion. The extractor pressure is maintained throughout extraction process in the phase two agitation chamber [Element 15.] ensuring the solvent remains in its liquid form.

11. A precise amount of oleiferous material is separated from the subject solids material feedstock in the phase two agitation chamber [Element 15.] creating an oleiferous/solvent emulsion. The oleiferous/solvent emulsion is drawn through a coarse filter [Element 16.] by vacuum pump [Element 17.] from the phase two agitation chamber [Element 15.] thus negating the need for a pressure differential. During the passage of the oleiferous/solvent emulsion through the coarse filter some particulate matter from the subject solids material feedstock remains in the oleiferous/solvent emulsion and will be removed at a later step in the separation process. The oleiferous/solvent emulsion is moved to the storage collection tank [Element 14.]. The subject solids material feedstock partially processed continues to transverse the extractor [Element 5.] with impeller [Element 8.] action and is carried into the phase three agitation chamber [Element 18.].

12. In the phase three agitation chamber [Element 18.], the impeller [Element 8] gently agitates, flays and propels subject solids material feedstock into separated and free floating particles.

13. A liquid gas solvent from pump [Element 9.], at a pressure greater than the resident extractor chamber pressure, transits and is injected through the spray nozzle manifold [Element 10.] by selected spray nozzles, creating different spray patterns [Element 11.] into the phase three agitation chamber [Element 18.] with a force, angle and droplet size to create a vortex of solvent and subject solids material feedstock in the phase three agitation chamber [Element 18.] which further agitates the subject solids material feedstock. The solvent saturates the agitated subject solids material feedstock particles causing the subject solids material feedstock to leach and create the precipitation of an oleiferous/solvent emulsion. The extractor pressure is maintained throughout extraction process in the phase three agitation chamber [Element 18.] ensuring the solvent remains in its liquid form.

14. A precise amount of oleiferous material is separated from the subject solids material feedstock in the phase three agitation chamber [Element 18.] creating an oleiferous/solvent emulsion. The oleiferous/solvent emulsion is drawn through a coarse filter [Element 19.] by vacuum pump [Element 20.] from the phase three agitation chamber [Element 18.] thus negating the need for a pressure differential. During the passage of the oleiferous/solvent emulsion through the coarse filter some particulate matter from the subject solids material feedstock remains in the oleiferous/solvent emulsion and will be removed at a later step in the separation process. The oleiferous/solvent emulsion is moved to the storage collection tank [Element 14.]. The subject solids material feedstock partially processed continues to transverse the extractor [Element 5.] with impeller [Element 8.] action and is carried into the phase four agitation chamber [Element 21.].

15. In the phase four agitation chamber [Element 21.], the impeller [Element 8] gently agitates, flays and propels subject solids material feedstock into separated and free floating particles.

16. A liquid gas solvent from pump [Element 9.], at a pressure greater than the resident extractor chamber pressure, transits and is injected through the spray nozzle manifold [Element 10.] by selected spray nozzles, creating different spray patterns [Element 11.] into the phase four agitation chamber [Element 21.] with a force, angle and droplet size to create a vortex of solvent and subject solids material feedstock in the phase four agitation chamber [Element 21.] which further agitates the subject solids material feedstock. The solvent saturates the agitated subject solids material feedstock particles causing the subject solids material feedstock to leach and create the precipitation of an oleiferous/solvent emulsion. The extractor pressure is maintained throughout extraction process in the phase four agitation chamber [Element 21.] ensuring the solvent remains in its liquid form.

17. A precise amount of oleiferous material is separated from the subject solids material feedstock in the phase four agitation chamber [Element 21.] creating an oleiferous/solvent emulsion. The oleiferous/solvent emulsion is drawn through a coarse filter [Element 22.] by vacuum pump [Element 23.] from the phase four agitation chamber [Element 21.] thus negating the need for a pressure differential. During the passage of the oleiferous/solvent emulsion through the coarse filter some particulate matter from the subject solids material feedstock remains in the oleiferous/solvent emulsion and will be removed at a later step in the separation process. The oleiferous/solvent emulsion is moved to the collection tank [Element 14.]. The subject solids material feedstock partially processed continues to transverse the extractor [Element 5.] with impeller [Element 8.] action and is carried into the phase five agitation chamber [Element 24.].

18. In the phase five agitation chamber [Element 24.], the impeller [Element 8] gently agitates, flays and propels subject solids material feedstock into separated and free floating particles.

19. A liquid gas solvent from pump [Element 9.], at a pressure greater than the resident extractor chamber pressure, is injected through the spray nozzle manifold [Element 10.] by selected spray nozzles, creating different spray patterns [Element 11.] into the phase five agitation chamber [Element 24.] with a force, angle and droplet size to create a vortex of solvent and subject solids material feedstock in the phase five agitation chamber [Element 24.] which further agitates the subject solids material feedstock. The solvent saturates the agitated subject solids material feedstock particles causing the subject solids material feedstock to leach and create the precipitation of an oleiferous/solvent emulsion. The extractor pressure is maintained throughout extraction process in the phase five agitation chamber [Element 24.] ensuring the solvent remains in its liquid form.

20. A precise amount of oleiferous material is separated from the subject solids material feedstock in the phase five agitation chamber [Element 24.] creating an oleiferous/solvent emulsion. The oleiferous/solvent emulsion is drawn through a coarse filter [Element 25.] by vacuum pump [Element 26.] from the phase five agitation chamber [Element 24.] thus negating the need for a pressure differential. During the passage of the oleiferous/solvent emulsion through the coarse filter some particulate matter from the subject solids material feedstock remains in the oleiferous/solvent emulsion and will be removed at a later step in the separation process. The oleiferous/solvent emulsion is moved to the storage collection tank [Element 14.]. The subject solids material feedstock partially processed continues to transverse the extractor [Element 5.] with impeller [Element 8.] action and is carried into the post extraction chamber [Element 27.].

21. A heating element [Element 28.], wrapped around the post extraction chamber [Element 27.], is heated to a temperature higher than the present ambient operating temperature, exact temperature depending upon application, beginning the process of eliminating lingering vapors from subject solids material feedstock. It is important that the movement through this chamber is continuous as to not adversely affect the vitamins and proteins contained in the subject solids materials.

22. The processed subject solids material exit the post extraction chamber [Element 27.] to enter a second proprietary valve assembly [Element 29.] that operates in a reverse but similar fashion as the first proprietary valve assembly. Thus, the subject solids material transit the valve from extractor pressure to atmospheric pressure without affecting the pressure in the extractor [Element 5.] or without releasing any resident vapors into the atmosphere.

23. An automated sensor [Element 30.] will provide a continuous reading of the percentage of oleiferous material remaining in the solids. This reading will be transmitted to the computer controlled feed, flow and force rates to make the necessary adjustments in the extraction process to reach the desired oleiferous material retained in the subject solid material feedstock. Additional sensors may be placed at the exit of each phased agitation chamber for precise control of percentage retained oleiferous material at each phase.

24. The subject solids material, now defatted, are moved to the feedstock finalizer [Element 31] that purges any residual vestiges of solvent from subject solids material by the application of minimum heat and slight vacuum.

25. The oleiferous/solvent emulsion from the pumps [Elements 13, 17, 20, 23, & 26.] now resides in collection tank [Element 14.]. This tank is depicted as a single unit. Depending upon application, each phased agitation chamber may empty into a single tank or into a combination of numbers of tanks as a solution to specific extraction requirements.

26. Pump [Element 32.] transfers oleiferous/solvent emulsion from collection tank [Element 14.] into a particulate filter [Element 33.] then to a proprietary oleiferous/solvent emulsion separation unit [Element 34.].

27. The oleiferous/solvent emulsion is separated into it two separate streams of oil and solvent by molecular weight, specific gravity, and/or viscosity differentials. Solvent remains in liquid phase during separation negating a requirement for recovery from gas to liquid.

28. The solvent stream from the separation unit [Element 34.] is returned under pressure by pump [Element 35.) to solvent recycle ready tank [Element 36.]. Solvent is maintained under pressure and in a liquid state in a closed-loop system.

29. The oleiferous stream enters the oil finalizer [Element 37.] that removes suspended subject solids material from feedstock agglomerating particles and purifies oleiferous material as required.

30. A pump [Element 9.] supplies recycled solvent to the recycle solvent manifold [Element 10.] then to the vortex spray nozzles [Element 11.] as described in the action of each phased agitation chamber.

31. A fresh solvent tank [Element 38.] provides clean or replacement solvent under pressure as needed through pump [Element 39.] at start up and during operations.

32. Oleiferous material for further use, analysis or disposal.

33. processed subject solids material for further use, analysis or disposal.

1. A new and improved extractor which incorporates a truly continuous process for the separation of virtually any carbonaceous and oleiferous content hereinafter called “oleiferous material” from the hereinafter called “subject solid materials” listed below:
Rendered animal tissue, industrial, commercial, domestic oleiferous wastes, oleiferous hazards, oleiferous industrial byproducts, oil bearing sands, strata, mineral, rock formation by inclusion and not by way of exclusion—fried or soaked substances inedible and edible, legumes and their hulls and casings, seeds and their hulls and casings and or shells, nuts and their hulls, casings and or shells, tree leafs and branches and roots, plant leafs and stems, basal leafs and branches and roots, marine life whether organic, mammal or aquatic, field crops and vegetables of every kind, for the separation of the solids from the fats and natural oils organically, intrinsically contained, held or suspended by or in them:
The subject solids material in pellet, flake or milled sizing passes through the extractor and leach and creates an oleiferous/solvent emulsion.

2. The extractor is a free standing, self contained, fully automated machine, and when required, fully mobile. Any single extractor is programmable and adaptable to extract predetermined percent of oleiferous material from many different subject solid materials, the subject solids material being virtually all oleiferous material. The extractor is a walled pressure chamber that is comprised of a single or of a series of contiguous phased agitation chamber(s); creating a structured plant component preferable in a horizontal position having accoutrements and appendages consisting of proprietary valve assemblages for the entry and the exiting of the subject solids material that accomplishes throughput from ambient to a pressure while not permitting the external and internal environments to mingle, these valves are driven by mechanical, electric motor or hydraulic motors that whose speed is controlled manually or automatically controlled by computer programming; a proprietary engineered continuous specially configured agitating impeller the length of the extractor driven by a hydraulic or electric motor whose speed is controlled either manually or by computer programming that cascades through and agitates the subject solids material in each of the phased agitation chambers; a specially configured pressured process solvent spraying apparatus that among other spray patterns continuously creates vortexes of agitated and co-mingled solvent and subject solid materials feedstock in each of the phased separation chamber(s); control valves that may be actuated and controlled by computer programming; a continuous filter system that employs mechanical, hydraulic or electric power driven pumps controlled by computer programming to maintain the flow rate and the flow of the oleiferous/solvent emulsion created by the agitating impeller action and the controlled pressure process solvent spraying, a coarse filter system that the leached oleiferous/solvent emulsion is drawn through by pump to a collection tank without a pressure differential at the filter then post pump secondary filters to remove any particulate or other desired/undesired remnants in the solvent/oleiferous material; a continuous filter system with pre-filter and post filters located at several places in the closed liquid solvent loop and solvent/oleiferous material emulsion lines; a continuous proprietary separation system that separates the oleiferous/solvent emulsion into two steams of liquid while maintaining the solvent in a liquid state by a pressure above the vapor point of the solvent throughout the closed-loop solvent system. A continuous monitoring of the residual oleiferous material in the processed subject solid materials entered into a computer data base that controls the action of the proprietary valves, the speed of the impeller, the force and amount of the solvent, the amount of suction through the coarse filters and fines filters for precise control of the oleiferous material in the finished solids. Finalizers condition the oil and solids to pre-determined conditions and to remove any desirable/undesirable remnants from each. The solvent is reused as an extraction agent while the solids and oleiferous materials are commuted for further application, commercialization or other uses.

3. The extractor consists of modular components and is truly continuous; there is no need or necessity for the subject solid materials or solvent to be batched at any phase in the extraction process. Extractor employs a single continuous system that will accept continuous flow of subject solid materials through its phased separation chamber(s) modularity allows for the customizing of individual extractors of single or multiple phased agitation chamber(s) and the customizing for each of the subject solid materials listed above. The extractor's modular components facilitate the management of the extraction of oleiferous material from the individual subject solid materials adjusting for their different chemical construction, susceptibility and acceptance to the solvent as a extracting agent, latency of the oleiferous material held by the subject solid materials which creates a timed response to the solvent, creating different extraction rates of the various subject solid materials. Similarly the separation and collection systems can be customized to accept different volume flows of oleiferous/solvent emulsion created by amount of solvent required to effect an efficient extraction to remove a predetermined and prescribed amount of oleiferous material from the subject solid materials listed above using a closed-loop solvent system that maintains the solvent as a liquid at all times.

4. Extractor operates at ambient temperatures and negates the use of the following:
fractionalization of the solvent,
creating press cake from the subject solids material,
slurries of any consistency from the subject solids material,
water at pressure or as a cleansing agent,
steam for serration,
maintained pressures greater than 10 atmospheres,
steam heat coils or cooling coils, the use of pulsating or fluctuating pressures,
differential pressures at the filter stage,
pre extractors,
counter flow applications,
soaking vats,
extraction zones,
processed vaporized solvent to liquid conversion processes,
heating of the subject solids material,
flashing off to atmosphere any retained process solvent in the subject solids material,
flaring off to atmosphere any used process solvent or the release of the process solvent in gas form into the atmosphere,
refrigeration

5. During the extraction process, the extractor's phased separation chamber(s) contain a sequenced array of events in which the feedstock is propelled into a separated and/or free floating state by the action of the specially configured impeller and further agitated and when necessary into a vortex by the spray action of spray nozzles that are sequenced and controlled by computer controlled actuating valves. These agitations and manipulations of the subject solid materials feedstock result in a co-mingling of the subject solids material with the solvent in the pressure and vacuumed-controlled environment in a continuous and non-compacting way and create greater exposure of the subject solid materials to the solvent resulting in improved exposure to the leaching and separation actions of the solvent. The extraction and separation processes are “gentle” allowing subject solid materials and the oleiferous material to maintain their molecular makeup, chemical structure and color. The vitamins and protein naturally occurring in both the oleiferous material and the subject solid materials are not harmed or denatured and remain undisturbed in their original chemical construction.

6. The extractor utilizes a duplicate proprietary valve assemblages and a proprietary separation assemblage.
The duplicate proprietary valve assemblages are located at the input and exiting ends of the extractor. The proprietary valve assemblages work in concert to feed the subject solid materials feedstock into the extractor or evacuate the subject solid materials feedstock from the extractor. To maintain pressure in the extractor the proprietary valve assemblages perform the following actions as they continually rotate:
meter the precise amount of subject solid materials feedstock,
transfer the metered subject solid materials feedstock from atmospheric pressure to extractor pressure in single continuous action,
purge the feedstock chamber(s) of the proprietary valve assemblage of ambient atmosphere to maintain the integrity of the extractor and the phased agitation chamber(s) by preventing the advent of moisture or loss of pressure,
remove any extraneous vapors by a second purging of the proprietary valve assemblages feedstock chamber after the release of the subject solid materials feedstock into the extractor,
seal the extractor from the atmosphere and maintain its pressurized environment.

7. The proprietary separation assemblage is configured to remove any remaining particulate from the solvent/oleiferous emulsion, to reconstitute the solvent/oleiferous emulsion into separate streams by separating and removing the liquid solvent from solvent/oleiferous emulsion that is then recycled to process additional subject solids material feedstock and the other, a pure oleiferous material exits extractor to atmosphere.

8. The extraction and separation processes are truly a continuous process for the subject solids material in which during the process low boiling paraffin including propane, butane and their types, other gaseous hydrocarbons and their types and mixtures of same, such other solvents as refrigerants and halogenated hydrocarbons and their types is applied to the subject solids material causing a leaching reaction that creates an oleiferous/solvent emulsion which is then separated into two streams and in which the process solvent is one stream and remains under pressure and in a liquid state at all times and is continually recycled for further and ongoing continuous processes and the other stream of oleiferous material exits the extractor for further use. The extraction process of the extractor is compatible with all nontoxic solvents and utilizes the naturally pure liquid gases, the preferred ones being non-explosive that are abundant, easy to obtain, nontoxic, low in health hazards and given a G.R.A.S. designation (Generally Regarded as Safe for food use) by the United States Food and Drug Administration.

9. That the extracted oleiferous/solvent emulsion may contain particulate from the commingling of the subject solids material with the solvent during the extraction process and may go through further suspended agglomerating particulate filtration processes upon or before entering the liquid/liquid Coalescer or mechanical separator for further purification and processing before the separation of the oleiferous/solvent emulsion into process extraction solvent and the oleiferous material.
